(19) United States
(12) Patent Application Publication
(10) Pub. No.: US 2024/0051057 A1
(43) Pub. Date: Feb. 15, 2024

(54) CABLE HOSE CONTROL FOR WELDING APPLICATIONS

(71) Applicants: William Joseph John Ottoshavett, Brentwood, CA (US); Lisa Marie Ottoshavett, Brentwood, CA (US)

(72) Inventors: William Joseph John Ottoshavett, Brentwood, CA (US); Lisa Marie Ottoshavett, Brentwood, CA (US)

(21) Appl. No.: 18/479,103

(22) Filed: Oct. 1, 2023

Related U.S. Application Data
(60) Provisional application No. 63/397,492, filed on Aug. 12, 2022.

(51) Int. Cl. B23K 9/32

(52) U.S. Cl. CPC B23K 9/32

(57) ABSTRACT

According to an aspect of the present invention, there is provided a Cable Hose Control assembly for a welder, comprising: an anchor hook configured with a passage for a welding cable; one or more retaining barbs for immobilizing the welding cable; a strap throughway positioned in the anchor hook; a strap configured to attach to the arm of the welder; and a strap brake.

### BACKGROUND

Metal Inert Gas (MIG) welding is an arc welding process in which a continuous solid wire electrode is fed through a welding gun and into the weld pool, joining the two base materials together. A shielding gas is also sent through the welding gun and protects the weld pool from contamination. Operation of a typical MIG welding torch, by way of example, is shown and described in U.S. Pat. Nos. 5,491,321 and 5,338,917.

It is well-known in the art that handling an arc welding torch for extended periods of time can be quite cumbersome to the end-user. Various solutions have been proposed for easing the burden on a welder.

For example, U.S. Ser. No. 10/493,554 discloses an ergonomic welding torch handle with interchangeable grips. A handle assembly includes a housing and an interchangeable saddle for customizing a geometrical grip of the handle. In one form, the housing includes an attachment feature and the interchangeable saddle includes a mating attachment feature to allow for the interchangeable saddle to be removably secured to an upper surface of the housing. Each interchangeable saddle defines a customized geometrical grip.

U.S. Ser. No. 10/427,252 discloses an ergonomic welding arm includes a plurality of arm links coupled by a plurality of joints. Each of the plurality of joints is configured to allow the plurality of arm links to be rotated about an axis with respect to a directly adjacent arm link. A first end of the welding arm is configured to engage a support for supporting the welding arm. A second end of the welding arm is configured to engage a welding torch.

Nonetheless, prior art solutions suffer from weaknesses including high cost and limited effectiveness.

### SUMMARY OF INVENTION

Therefore, the present invention provides an inexpensive means of reducing fatigue and improving welding process quality.

According to an aspect of the present invention, there is provided a Cable Hose Control assembly for a welder, comprising: an anchor hook configured with a passage for a welding cable; one or more retaining barbs for immobilizing the welding cable; a strap throughway positioned in the anchor hook; a strap configured to attach to the arm of the welder; and a strap brake.

According to another aspect of the present invention, there is provided method for preparing a welding operation, comprising: providing a welding gun with a cable; and positioning the cable in a Cable Hose Control assembly for a welder, comprising: an anchor hook configured with a passage for a welding cable; one or more retaining barbs for immobilizing the welding cable; a strap throughway positioned in the anchor hook; a strap configured to attach to the arm of the welder; and a strap brake.

### BRIEF DESCRIPTION OF THE DRAWINGS

FIG. 1 is a Cable Hose Control Vertical Assembly Blowout View.

FIG. 2 is a Cable Hose Control Vertical Assembly—Assembled.

FIG. 3 is a Cable Hose Control Horizontal Assembly Blowout View.

FIG. 4 is a Cable Hose Control Horizontal Assembly—Assembled.

FIG. 5 is a Cable Hose Control Vertical Assembly—Assembled—Side View.

FIG. 6 is a Cable Hose Control Vertical Assembly—Assembled—Front View.

FIG. 7 is a Cable Hose Control Vertical Assembly—Assembled—Back View.

FIG. 8 is a Cable Hose Control Vertical Assembly—Assembled—Top View.

FIG. 9 is a Cable Hose Control Vertical Assembly—Assembled—Bottom View.

FIG. 10 is a Cable Hose Control Horizontal Assembly—Assembled—Front View.

FIG. 11 is a Cable Hose Control Horizontal Assembly—Assembled—Side View.

FIG. 12 is a Cable Hose Control Horizontal Assembly—Assembled—Back View.

FIG. 13 is a Cable Hose Control Horizontal Assembly—Assembled—Top View.

FIG. 14 is a Cable Hose Control Horizontal Assembly—Assembled—Bottom View.

FIG. 15 shows a welder in typical welding position.

FIG. 16 shows a welder in typical welding position with Cable Hose Control.

FIG. 17 shows a typical welding situation.

FIG. 18 shows an improved welding situation with the Cable Hose Control.

FIG. 19 shows typical tig torch use.

FIG. 20 shows an improved tig welding situation.

FIG. 21 shows a typical oxygen and fuel gas cutting situation.

FIG. 22 shows an improved oxygen and fuel gas cutting situation with the Cable Hose Control.

### DETAILED DESCRIPTION

The Cable Hose Control of the present invention can either be used in horizontal orientation with the strap generally around the biceps of a welder or in vertical orientation with the strap generally around the forearm of a welder, as shown in the Figures described below.

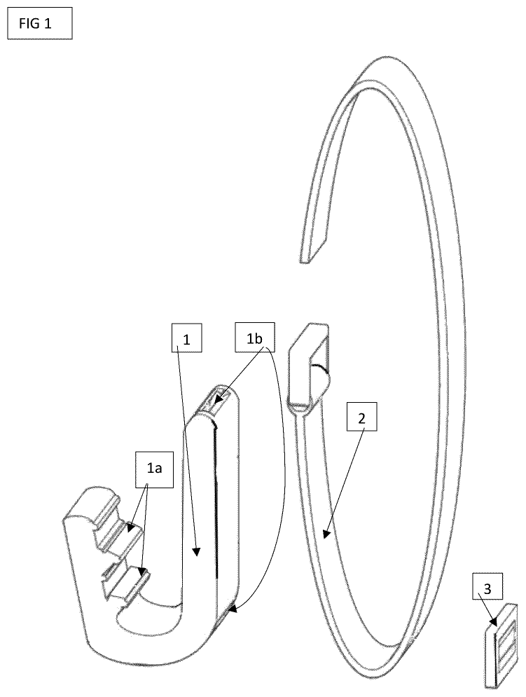

FIG. 1 is a Cable Hose Control Vertical Assembly Blowout View. Anchor hook 1 has retaining barbs 1a on one side and strap throughway 1b on the other side. Strap 2 goes through strap throughway 1b and attaches to the arm of a welder by strap brake 3.

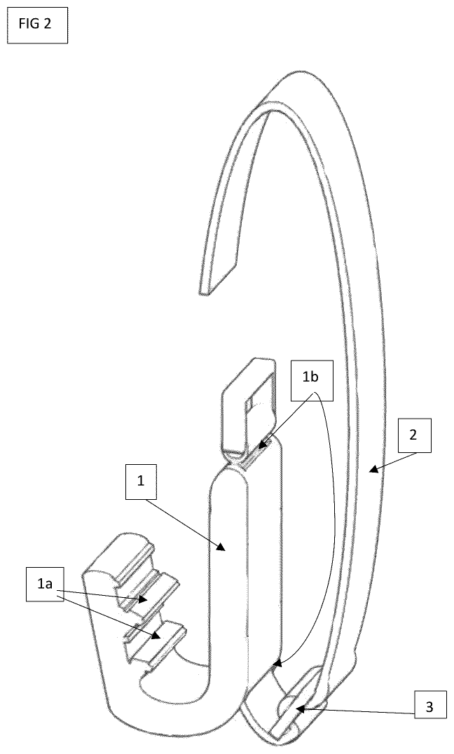

FIG. 2 is a Cable Hose Control Vertical Assembly—Assembled. Anchor hook 1 has retaining barbs 1a on one side and strap throughway 1b on the other side. Strap 2 goes through strap throughway 1b and attaches to the arm of a welder by strap brake 3.

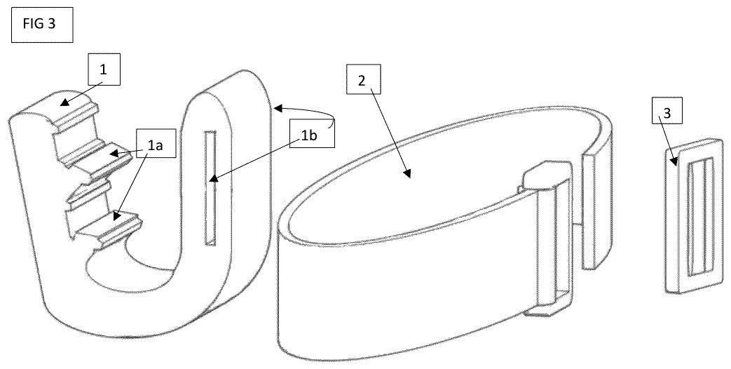

FIG. 3 is a Cable Hose Control Horizontal Assembly Blowout View. Anchor hook 1 has retaining barbs 1a on one side and strap throughway 1b on the other side. Strap 2 goes through strap throughway 1b and attaches to the arm of a welder by strap brake 3.

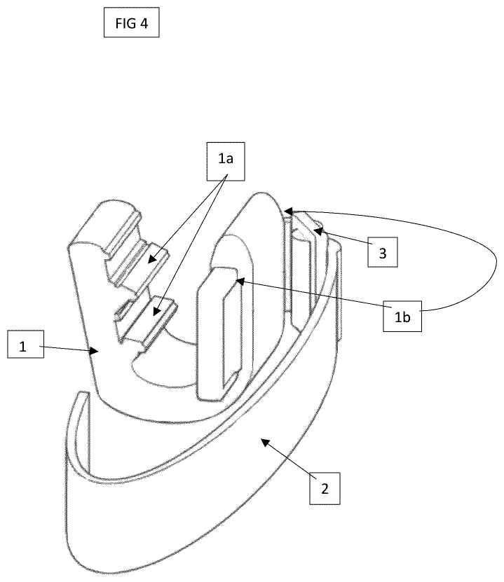

FIG. 4 is a Cable Hose Control Horizontal Assembly—Assembled. Anchor hook 1 has retaining barbs 1a on one side and strap throughway 1b on the other side. Strap 2 goes through strap throughway 1b and attaches to the arm of a welder by strap brake 3.

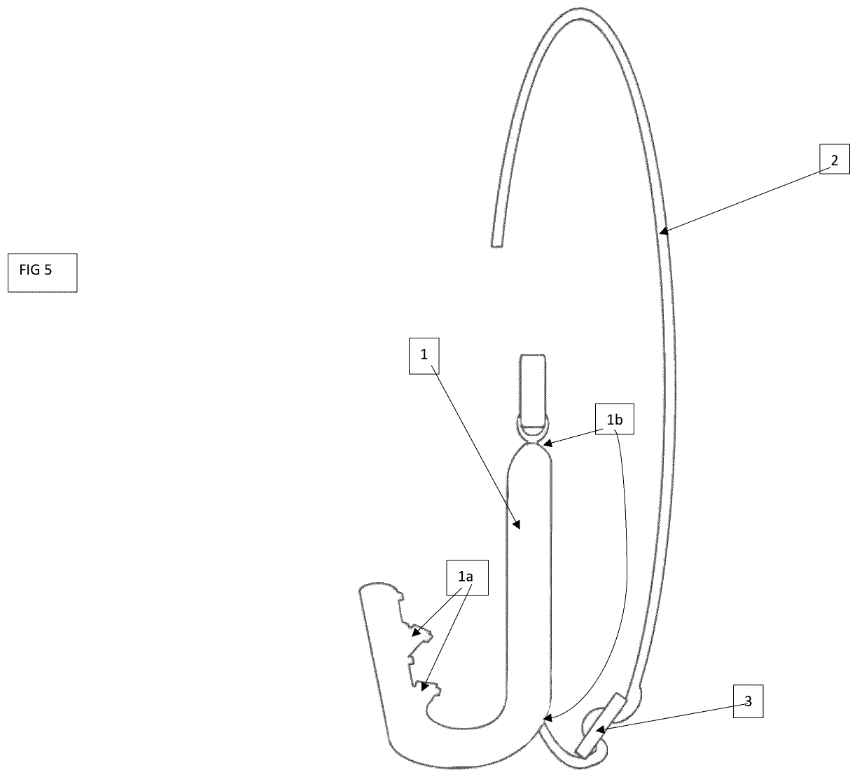

FIG. 5 is a Cable Hose Control Vertical Assembly—Assembled—Side View. Anchor hook 1 has retaining barbs 1a on one side and strap throughway 1b on the other side. Strap 2 goes through strap throughway 1b and attaches to the arm of a welder by strap brake 3.

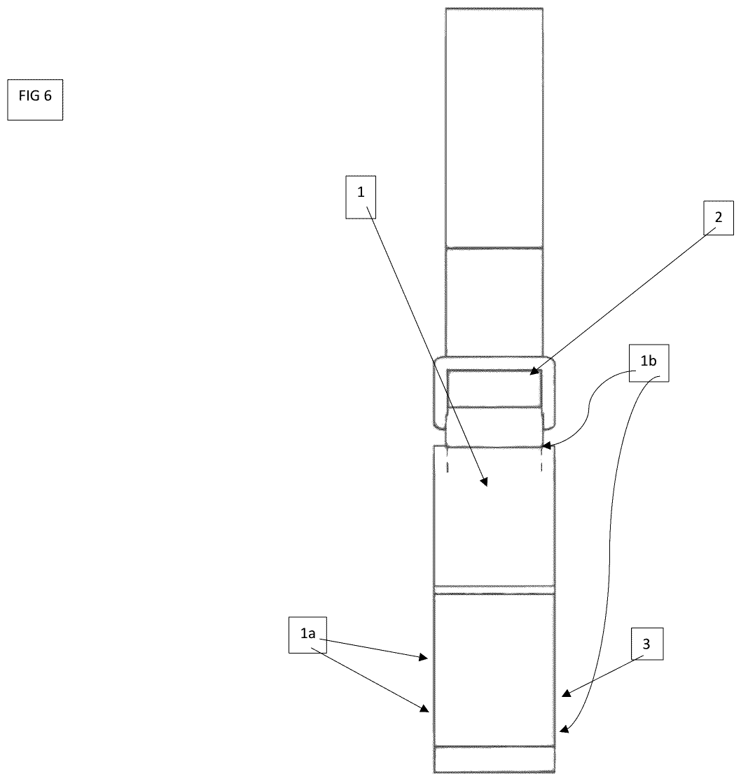

FIG. 6 is a Cable Hose Control Vertical Assembly—Assembled—Front View. Anchor hook 1 has retaining barbs 1a on one side and strap throughway 1b on the other side. Strap 2 goes through strap throughway 1b and attaches to the arm of a welder by strap brake 3.

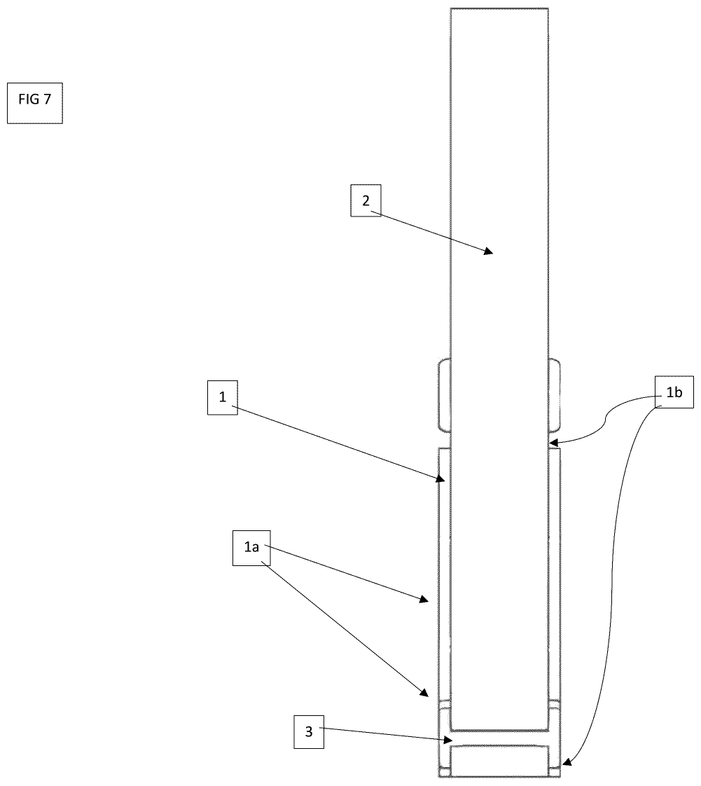

FIG. 7 is a Cable Hose Control Vertical Assembly—Assembled—Back View. Anchor hook 1 has retaining barbs 1a on one side and strap throughway 1b on the other side. Strap 2 goes through strap throughway 1b and attaches to the arm of a welder by strap brake 3.

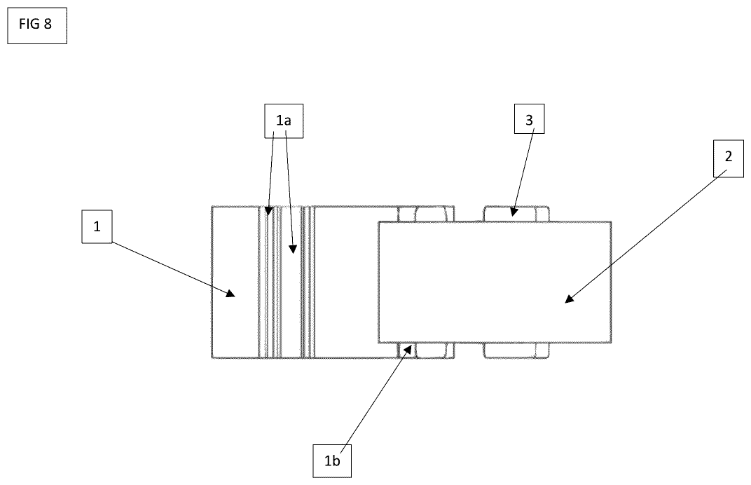

FIG. 8 is a Cable Hose Control Vertical Assembly—Assembled—Top View. Anchor hook 1 has retaining barbs 1a on one side and strap throughway 1b on the other side. Strap 2 goes through strap throughway 1b and attaches to the arm of a welder by strap brake 3.

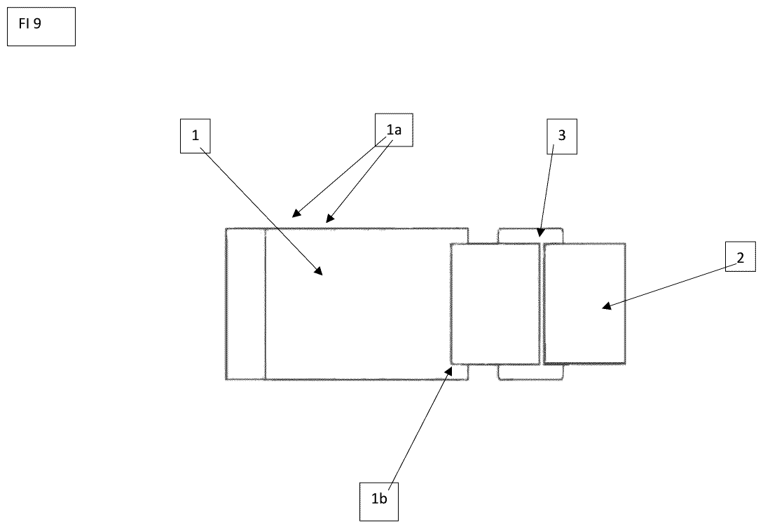

FIG. 9 is a Cable Hose Control Vertical Assembly—Assembled—Bottom View. Anchor hook 1 has retaining barbs 1a on one side and strap throughway 1b on the other side. Strap 2 goes through strap throughway 1b and attaches to the arm of a welder by strap brake 3.

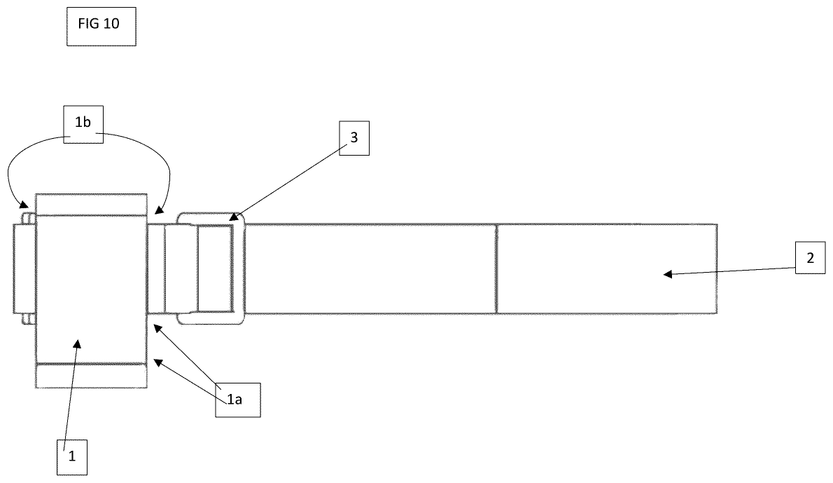

FIG. 10 is a Cable Hose Control Horizontal Assembly—Assembled—Front View. Anchor hook 1 has retaining barbs 1a on one side and strap throughway 1b on the other side. Strap 2 goes through strap throughway 1b and attaches to the arm of a welder by strap brake 3.

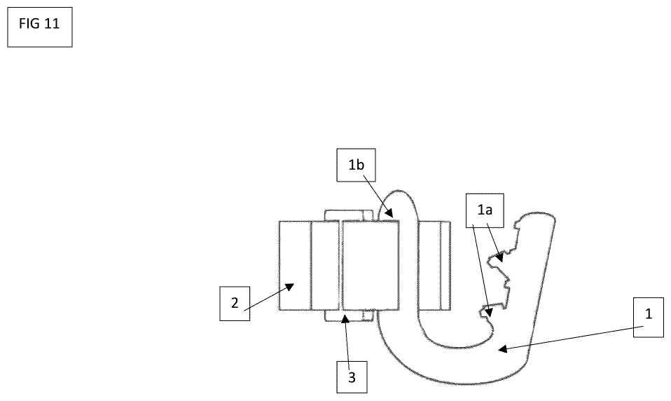

FIG. 11 is a Cable Hose Control Horizontal Assembly—Assembled—Side View. Anchor hook 1 has retaining barbs 1a on one side and strap throughway 1b on the other side. Strap 2 goes through strap throughway 1b and attaches to the arm of a welder by strap brake 3.

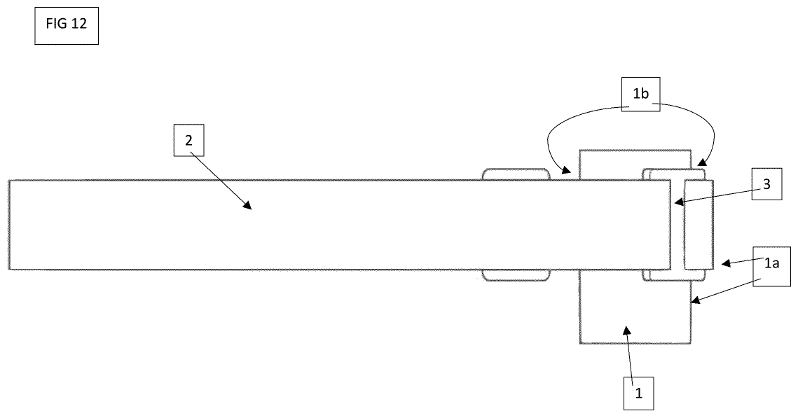

FIG. 12 is a Cable Hose Control Horizontal Assembly—Assembled—Back View. Anchor hook 1 has retaining barbs 1a on one side and strap throughway 1b on the other side. Strap 2 goes through strap throughway 1b and attaches to the arm of a welder by strap brake 3.

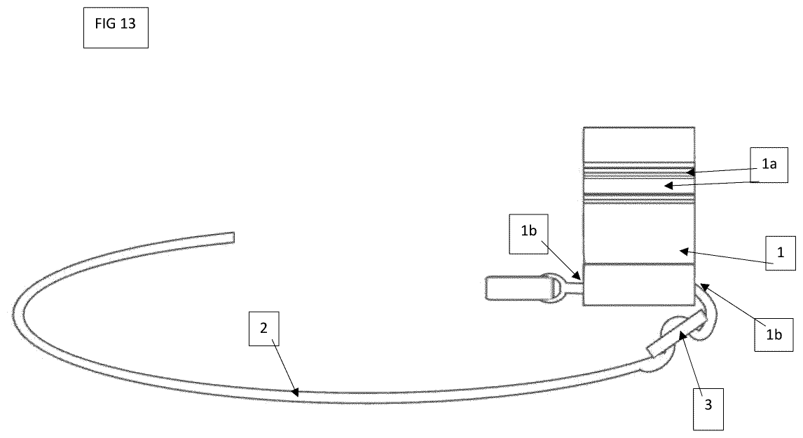

FIG. 13 is a Cable Hose Control Horizontal Assembly—Assembled—Top View. Anchor hook 1 has retaining barbs 1a on one side and strap throughway 1b on the other side. Strap 2 goes through strap throughway 1b and attaches to the arm of a welder by strap brake 3.

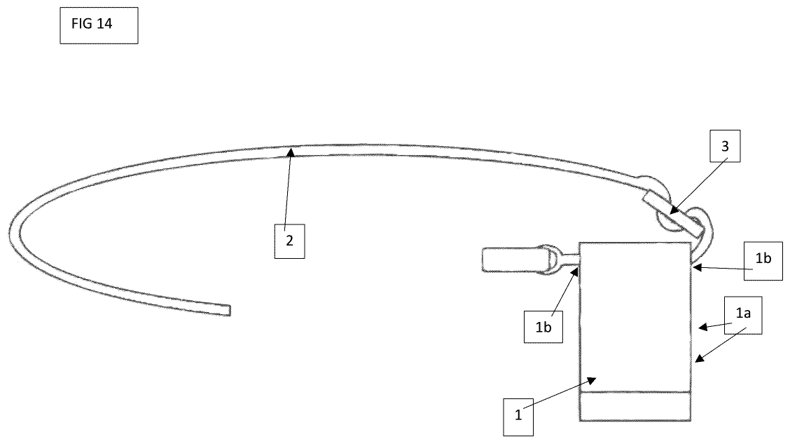

FIG. 14 is a Cable Hose Control Horizontal Assembly—Assembled—Bottom View. Anchor hook 1 has retaining barbs 1a on one side and strap throughway 1b on the other side. Strap 2 goes through strap throughway 1b and attaches to the arm of a welder by strap brake 3.

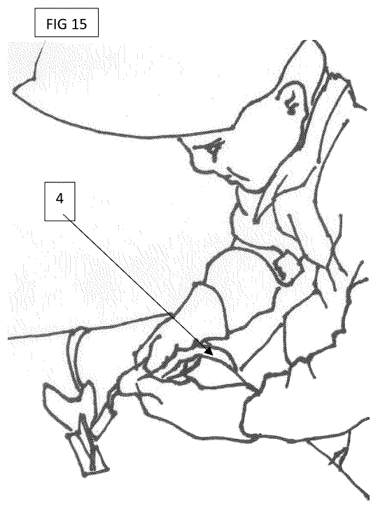

FIG. 15 shows a welder in typical welding position with the Mig gun in front of the welder with all the weight & stress placed on the welder's wrist. Welding Lead 4 is held by the welder.

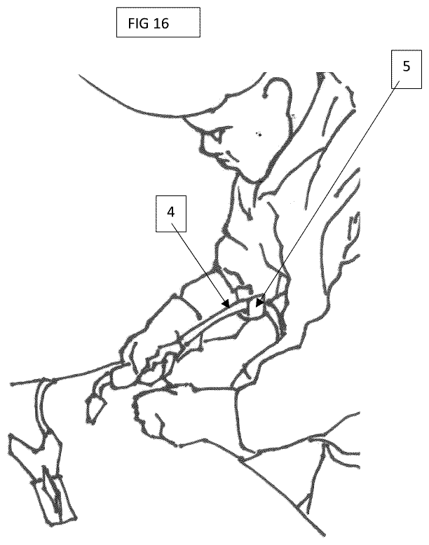

FIG. 16 shows a welder in typical welding position with the Mig gun redirected to the side of the welder with the CHC. Welding Lead 4 runs through Cable Hose Control 5. Now the weight and stress is relocated near the elbow stabilizing the wrist and reducing fatigue.

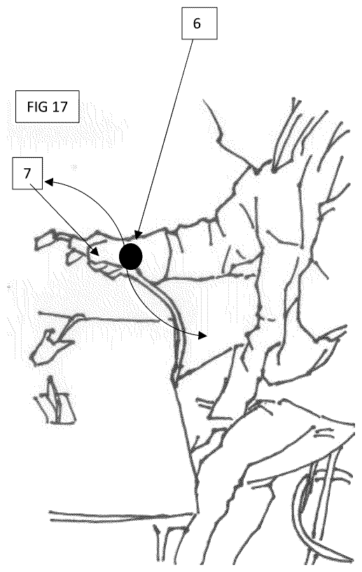

FIG. 17 shows a typical welding situation with a single mount/hand as the only stabilizer. As a result, the wrist is Pivot Point & Motion Potential 6 pivot point causing un-wanted motion due to the weight and awkwardness of the cable for Hand of Welder 7. These issues cause quality reduction and increase waste. Additional unwanted movement can also cause fatigue and possible injury.

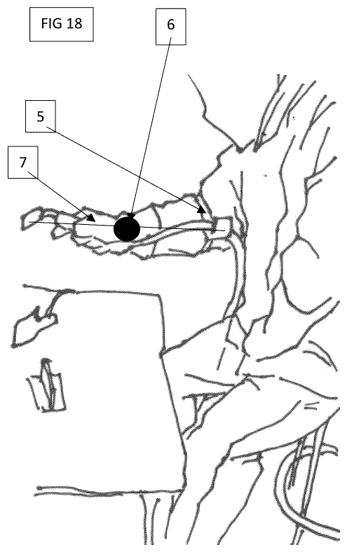

FIG. 18 shows an improved welding situation with a dual mount/hand and Cable Hose Control 5 as stabilizers. The result is a restricted Pivot Point & Motion Potential 6 limiting Hand of Welder 7 to a minimal amount of motion improving process quality and efficiency. In addition, the decrease in failed production saves on labor and material cost. The reduction of unwanted and potentially harmful repetitive motion may reduce the chance of injury.

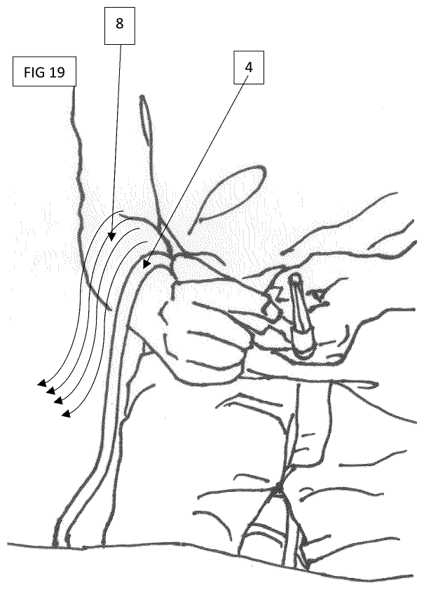

FIG. 19 shows typical tig torch use. Single mount/hand allows the wrist to be a pivot point. The positioning of the torch also creates awkwardness and weight placed on wrist. The torch may roll and result in the welder's uncertainty of where to put the cable. Welding Lead 4 and Potential Motion 8 in turn causes a reduction in focus.

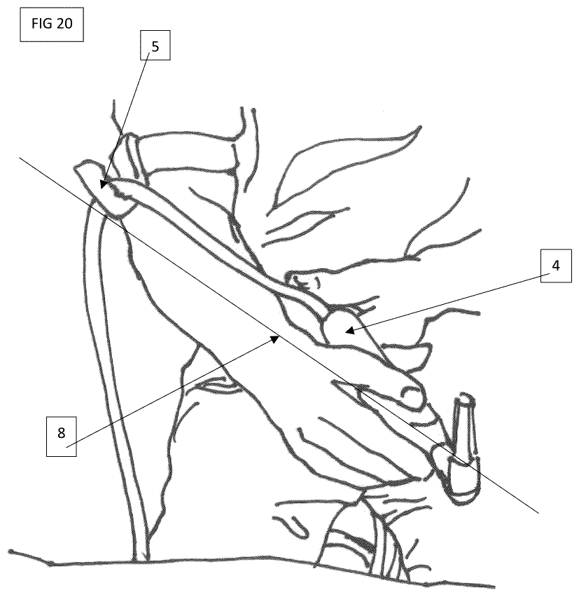

FIG. 20 shows an improved tig welding situation. Dual mounts including the hand and Cable Hose Control restricts the movement of the wrist as a pivot point. It also transitions most of the weight to the elbow area. The weight and awkwardness are lessened lowering the welder's uncertainty of where to place the cable. Welding Lead 4 and Potential Motion 8 are constrained by Cable Hose Control 5. The effect of this is increased focus improving quality and efficiency.

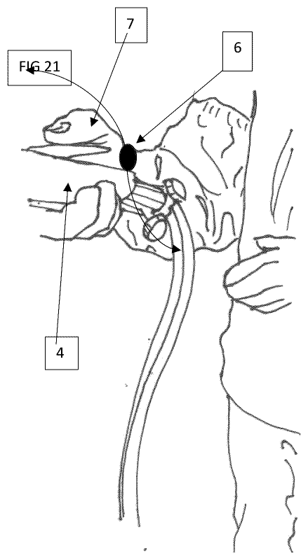

FIG. 21 shows a typical oxygen and fuel gas cutting situation with a single mount/hand as the only stabilizer for Welding Lead 4. As a result, the wrist is Pivot Point & Motion Potential 6 causing un-wanted Hand of Welder 7 motion due to the weight and awkwardness of the cutting torch and hoses. These issues cause quality reduction and increase waste. Additional unwanted movement can also cause fatigue and possible injury.

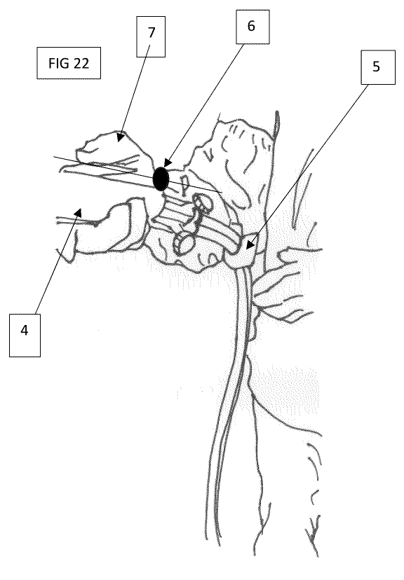

FIG. 22 shows an improved oxygen and fuel gas cutting situation with a dual mount/hand and Cable Hose Control 5 as stabilizers of Welding Lead 4. The result is a restricted Pivot Point & Motion Potential 6 limiting Hand of Welder 7 to a minimal amount of motion improving process quality and efficiency. In addition, the decrease in failed production saves on labor and material cost. The reduction of unwanted and potentially harmful repetitive motion may reduce the chance of injury.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A Cable Hose Control assembly for a welder, comprising:
an anchor hook configured with a passage for a welding cable;
one or more retaining barbs for immobilizing the welding cable;
a strap throughway positioned in the anchor hook;
a strap configured to attach to the arm of the welder;
and a strap brake.

2. The Cable Hose Control assembly of claim 1, wherein the Anchor Hook is U-shaped.

3. The Cable Hose Control assembly of claim 1, wherein the strap is configured to attach to the biceps of the welder.

4. The Cable Hose Control assembly of claim 1, wherein the strap is configured to attach to the forearm of the welder.

5. The Cable Hose Control assembly of claim 3, wherein the anchor hook is oriented horizontally.

6. The Cable Hose Control assembly of claim 4, wherein the anchor hook is oriented vertically.

7. A method for preparing a welding operation, comprising:
providing a welding gun with a cable; and
positioning the cable in a Cable Hose Control assembly for a welder, comprising:
an anchor hook configured with a passage for a welding cable;
one or more retaining barbs for immobilizing the welding cable;
a strap throughway positioned in the anchor hook;
a strap configured to attach to the arm of the welder;
and a strap brake.

8. The method of claim 7, wherein the anchor hook is oriented horizontally.

9. The method of claim 7, wherein the anchor hook is oriented vertically.
